(19) United States
(12) Patent Application Publication
(10) Pub. No.: US 2005/0083058 A1
(43) Pub. Date: Apr. 21, 2005

(54) Superconducting magnet, process for producing the same and its magnetizing method

(76) Inventors: Ikuo Itoh, Chiba (JP); Hiroaki Otsuka, Chiba (JP); Mitsuru Sawamura, Chiba (JP)

Correspondence Address: KENYON & KENYON, ONE BROADWAY, NEW YORK, NY, 10004, US

(21) Appl. No.: 10/506,206

(22) PCT Filed: Dec. 12, 2003
(86) PCT No.: PCT/JP03/15989

(30) Foreign Application Priority Data
Dec. 13, 2002 (JP) 2002362228

(51) Int. Cl. G01V 3/00

(52) U.S. Cl. 324/318

(57) ABSTRACT

A superconductive magnet comprised of a bulk member or sheet member of a type II superconductive material, wherein a distribution of the magnetic flux density component vertical to the surface directly above the surface of the bulk member or sheet member (a) has a maximum value at a center of said bulk member or sheet member and is about zero at its side edge, and (b) has at least one minimal value point between said center and side edge. A superconductor is cooled to not more than a critical temperature after applying a magnetic field Hex1 [A/m] near the magnetic field generation system in the normal conductive state, then the applied magnetic field is reduced to zero, then a magnetic field is applied until the applied magnetic field becomes −Hex2 [A/m] in the opposite direction to the trapped magnetic flux to make the trapped magnetic flux density Bin0 [T], then the applied magnetic field is again returned to zero, where Hex1>0 and Hex2>0.

### TECHNICAL FIELD

The present invention relates to a method of utilizing a magnetic flux trapping property of a type II superconductive material so as to utilize the type II superconductive material as a permanent magnet, wherein predetermined shapes of type II superconductive materials are stacked to produce a superconductive magnet, a method of magnetization suppressing a drop in the trapped magnetic flux density due to the elapse of time, called “magnetic flux creep”, to magnetize a superconductive magnet so that a stable magnetic flux density is generated over time, and a superconductive magnet generating a magnetic flux density stable over time.

### BACKGROUND ART

A type II superconductive material has almost always up until now been wound in a coil as a superconductive wire material and researched and developed as a permanent magnet utilizing the superconductive permanent current in the form of a superconductive magnet.

As applications commercialized up to the present and as applications during development, a medical use image diagnosis system utilizing the phenomenon of nuclear magnetic resonance (hereinafter referred to as an “MRI”), magnetic levitation trains, particle accelerators, nuclear fusion reactors, physical property measurement systems, etc. may be mentioned.

A bulk type II superconductor has a small self inductance, so the change of the trapped magnetic flux density is large. This phenomenon is called “magnetic flux creep”.

Magnetic creep occurs due to movement of the quantum magnetic flux fixed at pinning points due to thermal rocking. Unless this is avoided, a flow of magnetic flux (magnetic flux flow) occurs, resistance is generated causing heat, and under some conditions the superconductive state is destroyed.

When utilizing the stationary magnetic field of a type II superconductor, the requirement for stability of the magnetic field generated is considerably severe. In particular, in an MRI, the center of the superconductive magnet forming the diagnostic region is required to be extremely uniform and stable in magnetic field both spatially and time-wise.

For example, a strict magnetic field of not more than several ppm and not more than 0.1 ppm/hr in a 30 cm spherical space is required. In applications like an MRI where a uniform and stable magnetic field is required, if the magnetic field produced changes over time, the magnetic field will not be useful at all.

To prevent such magnetic flux creep of a superconductive coil, the method of reducing the pressure of the liquid nitrogen in which the oxide superconductive coil is immersed to cool the superconductive coil to a temperature lower than the normal liquid nitrogen temperature of 77 K for use is disclosed in Japanese Unexamined Patent Publication (Kokai) No. 4-350906.

Further, in the same way, as a method for suppressing magnetic flux creep of an oxide superconductor, the method of increasing the rate of magnetization and demagnetization and raising the material temperature once, demagnetizing, then, when the temperature drops again, stabilizing the trapped magnetic flux density is disclosed in Japanese Unexamined Patent Publication (Kokai) No. 6-20837.

These methods are all methods for controlling the temperature of the refrigerant or material to hold the superconductive current after trapping the magnetic flux at not more than the Jc (critical current density).

However, with these methods, in addition to an ordinary magnetization mechanism, a temperature control system including a heater becomes necessary. Further, since it is necessary to bring the heater etc. into contact with the superconductor, detachment of the heater and other devices after magnetization is extremely difficult.

Further, in a plurality of cylindrical members stacked concentrically, the method of using a heater to partially control the temperature to attain the normal conductive state and allow a DC magnetic flux to pass and then applying an AC magnetic field is disclosed in Japanese Unexamined Patent Publication (Kokai) No. 8-279411. However, with this method, in addition to an ordinary magnetization mechanism, a heater and temperature control system are required and further an AC magnetic field application system is required.

Further, with this method, it is necessary to hold at least one, from the innermost side, up to (N−1) number of the plurality (N number) of cylindrical superconductors stacked concentrically at the normal conductive state and make the outer cylindrical superconductors the superconductive state.

Therefore, in this method, a heat insulating mechanism becomes necessary at the boundary between the normal conductive state and the superconductive state and the temperature control becomes complicated, so the cost of fabrication of superconductive magnets rises.

To solve this problem, as a method for realizing magnetization by an ordinary magnetization mechanism, the method, when magnetizing in the superconductive state in a zero magnetic field, of stopping the magnetization by an applied magnetic field Hex1 before the magnetic flux density of the center of a bulk member or sheet member or the inside wall part of a cylindrical member reaches the trapped maximum magnetic flux density Binmax, demagnetizing monotonously until zero to end the magnetization, providing a bending point of the magnetic flux density at the high part of the trapped magnetic flux density distribution, that is, the so-called peak side of the distribution, and thereby stabilizing the magnetic flux density is disclosed in Japanese Unexamined Patent Publication (Kokai) No. 8-273921.

However, with this method, since there is a bending point of the magnetic flux density becoming maximum at the peak side, it is not possible to keep the magnetic flux from moving to the lower magnetic flux density along with the inclination of the trapped magnetic flux density and there is a limit to the capability of suppression of the magnetic flux creep.

### SUMMARY OF THE INVENTION

The present invention provides a superconductive magnet obtained by magnetizing a superconductor by a simple magnetization system at a low cost, superior in the ability to suppress magnetic flux creep, and able to overcome the various problems in the above prior art.

The inventors discovered that if providing a bending points near the outskirts of the inclined parts in the trapped magnetic flux density distribution, it is possible to stop the magnetic flux moving from the peak side of the magnetic flux density distribution to the low side and dropping sharply near the outskirts and, as a result, the occurrence of magnetic flux creep can be remarkably suppressed.

The present invention was made based on this discovery and has as its gist the following:

(1) A superconductive magnet comprised of a bulk member or sheet member of a type II superconductive material,
said superconductive magnet characterized in that a distribution of the magnetic flux density component vertical to the surface directly above the surface of the bulk member or sheet member
(a) has a maximum value at a center of said bulk member or sheet member and is about zero at its side edge, and
(b) has at least one minimal value point between said center and side edge.

(2) A superconductive magnet as set forth in (1), characterized in that the distribution of said magnetic flux density component has one maximal value point between the minimal value point closest to said side edge and said side edge.

(3) A superconductive magnet as set forth in (1) or (2), characterized in that the distribution of said magnetic flux density component has (N−1) number of maximal value points and has N number of minimal value points between said center and side edge and said side edge.

(4) A superconductive magnet as set forth in (1) or (2), characterized in that the distribution of said magnetic flux density component has N number of maximal value points and N number of minimal value points between said center and side edge.

(5) A superconductive magnet as set forth in any one of (1) to (4), characterized in that said bulk member or sheet member is comprised of at least N number (where N=2) of bulk members or sheet members of a type II superconductive material stacked in the thickness direction.

(6) A superconductive magnet as set forth in any one of (1) to (5), characterized in that said bulk member or sheet member is comprised of a type II superconductive material layer and normal conductive material layer stacked alternately and bonded metallically at the stacked boundaries.

(7) A superconductive magnet as set forth in (6), characterized in that said stacked boundaries have diffusion barrier layers.

(8) A superconductive magnet comprised of a seamless cylindrical member of a type II superconductive material,
said superconductive magnet characterized in that a distribution of the magnetic flux density component parallel to the center axis of said cylindrical member in a plane vertical to the center axis
(a) has a maximum value at the inside surface of said cylindrical member and is substantially zero at the outside surface, and further,
(b) has at least one minimal value point between said inside surface and outside surface.

(9) A superconductive magnet as set forth in (8), characterized in that the distribution of said magnetic flux density component has one maximal value point between the minimal value point closest to said outside surface and said outside surface.

(10) A superconductive magnet as set forth in (8) or (9), characterized in that the distribution of said magnetic flux density component has (N−1) number of maximal value points and has N number of minimal value points between said inside surface and outside surface.

(11) A superconductive magnet as set forth in (8) or (9), characterized in that the distribution of said magnetic flux density component has N number of maximal value points and N number of minimal value points between said inside surface and outside surface.

(12) A superconductive magnet as set forth in any one of (8) to (11), characterized in that said seamless cylindrical member is comprised of at least N number (where N=2) of seamless cylindrical members of a type II superconductive material stacked in the thickness direction.

(13) A superconductive magnet as set forth in any one of (8) to (11), characterized in that said seamless cylindrical member is comprised of a type II superconductive material layer and normal conductive material layer stacked alternately and bonded metallically at the stacked boundaries.

(14) A superconductive magnet as set forth in (13), characterized in that said stacked boundaries have diffusion barrier layers.

(15) A superconductive magnet as set forth in any one of (6), (7), (13), and (14), characterized in that said type II superconductive material is any one of an NbTi-based alloy, Nb₃Sn, and V₃Ga and said normal conductive material is at least one type of material among copper, a copper alloy, aluminum, or an aluminum alloy.

(16) A superconductive magnet as set forth in any one of (1) to (5) and (8) to (12), characterized in that said type II superconductive material is an oxide-based superconductive material.

(17) A method of production of a superconductive magnet as set forth in any one of (5) to (7) and (12) to (14), characterized in that said N number or more type II superconductive materials are stacked in the thickness direction shifted by angles of (180/N)° each.

(18) A magnetization method of a superconductive magnet characterized by:
cooling a superconductor comprised of a bulk member, sheet member, or cylindrical member of a type II superconductive material to not more than a critical temperature while applying a magnetic field Hex1 [A/m] near the magnetic field generation system in the normal conductive state,
reducing the applied magnetic field to zero,
applying a magnetic field until the applied magnetic field becomes −Hex2 [A/m] in the opposite direction to the trapped magnetic flux to make the trapped magnetic flux density Bin0[T], then
again returning the applied magnetic field to zero, where
   Hex1>0, Hex2>0.

(19) A magnetization method of a superconductive magnet as set forth in (18), characterized by: further,
reversing the direction of the applied magnetic field to a direction the same as the trapped magnetic field and applying a magnetic field until Hex3 [A/m], then
returning the applied magnetic field to zero, where
   Hex1>0, Hex2>0, Hex3>0.

(20) A magnetization method of a superconductive magnet as set forth in (19), characterized by: further,
reversing the direction of the applied magnetic field and repeatedly applying the magnetic field until Hex(2N−1) or Hex(2N), and
finally returning the applied magnetic field to zero, where
Hex(2N−1)>0, Hex(2N)>0, N=1, 2, . . . , n (n is a natural number).

### BRIEF DESCRIPTION OF THE DRAWINGS

FIG. 1 is a view showing the change of a magnetic flux density distribution obtained by the magnetization method of applying to a superconductor comprised of at least one of a bulk member, sheet member, or cylindrical member of a type II superconductive material an external magnetic field Hex1 under a normal conductive state, then cooling to a superconductive state to trap the magnetic flux density μoHex1, then demagnetizing to −Hex2, then returning to a zero magnetic field. (a) shows the change of the magnetic flux density distribution in the case of a circular bulk member or circular sheet member, while (b) shows the change of the magnetic flux density distribution in the case of a cylindrical member.

FIG. 2 is a view showing the change of a magnetic flux density distribution obtained by the conventional magnetization method of applying to a superconductor comprised of at least one of a bulk member, sheet member, or cylindrical member of a type II superconductive material an external magnetic field Hex1 under a normal conductive state, then cooling to a superconductive state to trap the magnetic flux density μoHex1, then returning to a zero magnetic field. (a) shows the change of the magnetic flux density distribution in the case of a circular bulk member or circular sheet member, while (b) shows the change of the magnetic flux density distribution in the case of a cylindrical member.

FIG. 3 is a view showing the relationship between an externally applied magnetic flux density and the magnetic flux density inside the superconductor in the case of μoHex1≧Binmax in the process of applying to a superconductor comprised of at least one of a bulk member, sheet member, or cylindrical member of a type II superconductive material an external magnetic field Hex1 under a normal conductive state, then cooling to a superconductive state to trap the magnetic flux density μoHex1, then demagnetizing to −Hex2, then returning to a zero magnetic field.

FIG. 4 is a view of the relationship between the externally applied magnetic flux density and the magnetic flux density inside the superconductor in the case of μoHex1≦Binmax−μoHex2 in the above magnetization process.

FIG. 5 is a view of the relationship between the externally applied magnetic flux density and the magnetic flux density inside the superconductor in the case of Binmax−μoHex2<μoHex1≦Binmax in the above magnetization process.

FIG. 6 is a view showing the change of a magnetic flux density distribution obtained by the magnetization method of applying to a superconductor comprised of at least one of a bulk member, sheet member, or cylindrical member of a type II superconductive material an external magnetic field Hex1 under a normal conductive state, then cooling to a superconductive state to trap the magnetic flux density μoHex1, then demagnetizing to −Hex2, then magnetizing to +Hex2, then returning to a zero magnetic field. (a) shows the change of the magnetic flux density distribution in the case of a circular bulk member or circular sheet member, while (b) shows the change of the magnetic flux density distribution in the case of a cylindrical member.

FIG. 7 is a view showing the change of a magnetic flux density distribution obtained by the magnetization method of applying to a superconductor comprised of at least one of a bulk member, sheet member, or cylindrical member of a type II superconductive material an external magnetic field Hex1 under a normal conductive state, then cooling to a superconductive state to trap the magnetic flux density μoHex1, then demagnetizing to −Hex2, then magnetizing to +Hex3, then demagnetizing to −Hex4, then returning to a zero magnetic field. The figure shows the change in the magnetic flux density distribution in the left half of the circular bulk member or circular sheet member or cylindrical member. Here, Hex2>0, Hex3>0, and Hex4>0.

FIG. 8 is a view comparing the change along with time in the trapped magnetic flux density of a superconductor magnetized by one of the magnetization methods of the present invention due to magnetic flux creep and the change along with time in the trapped magnetic flux density of the same superconductor magnetized by the conventional magnetization method due to magnetic flux creep. (a) shows the change along with time by the linear time, while (b) shows the change along with time by the logarithmic time.

### THE MOST PREFERRED EMBODIMENT

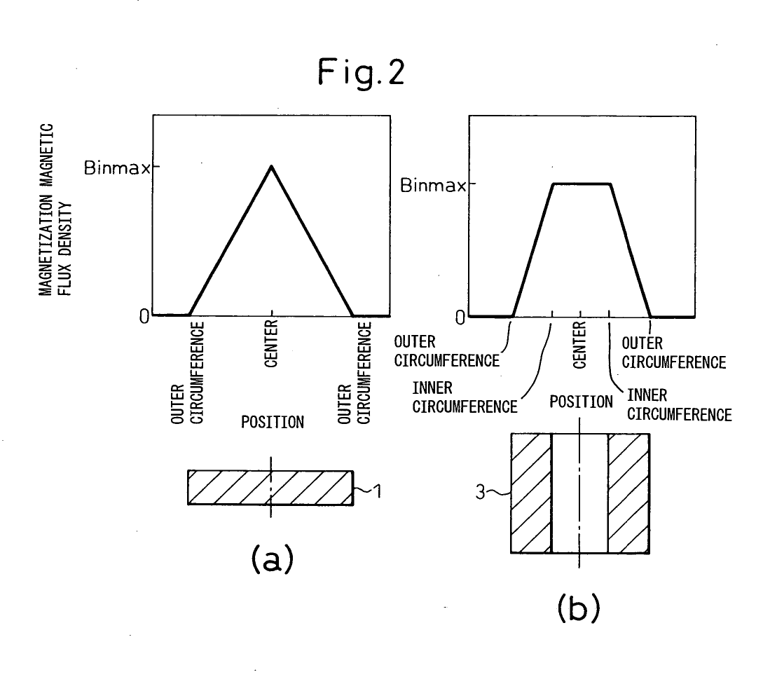

When using a general conventional method to magnetize a bulk member or sheet member of a type II superconductive material, the distribution of the magnetic flux density component vertical to the surface right above the surface of the bulk member or sheet member is shown in FIG. 2(a) and the distribution of the magnetic flux density component parallel to the center axis in the plane vertical to the center axis in the case of magnetization of the seamless cylindrical member of the type II superconductive material is shown in FIG. 2(b).

Both magnetic flux density distributions have maximum values at the center or the inside surface of the cylindrical wall. The values monotonously decrease toward the outer circumferences, then become substantially zero at the side edge or the outer surface of the cylinder wall.

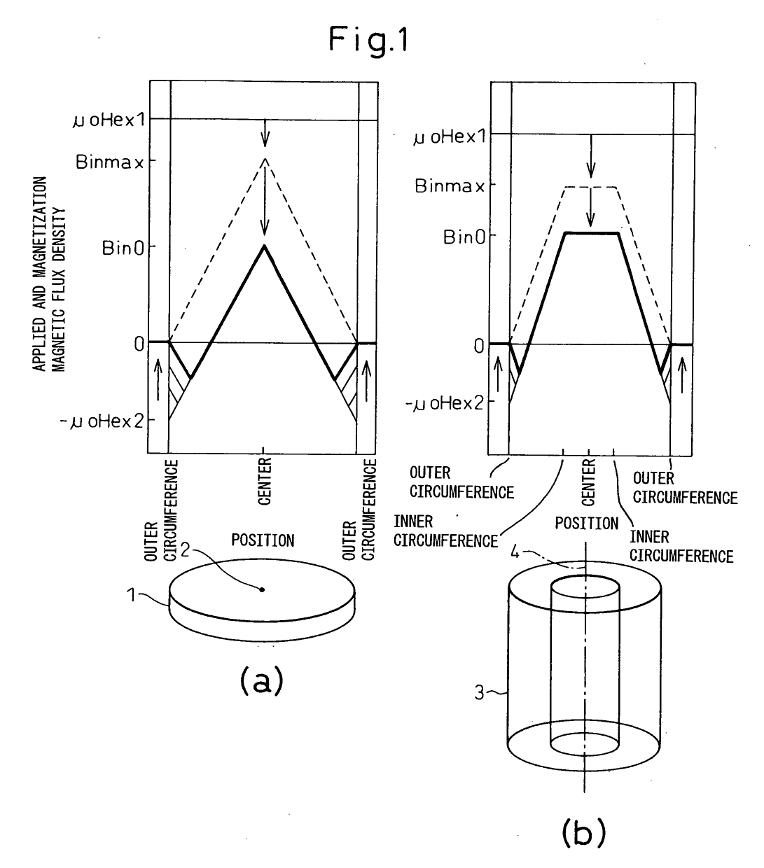

As opposed to this, the first aspect of the invention in the present invention provides a superconductive magnet comprised of a bulk member or sheet member of a type II superconductive material wherein a distribution of the magnetic flux density component vertical to the surface directly above the surface of the bulk member or sheet member, as shown in FIG. 1(a), has a maximum value at a center of said bulk member or sheet member and is about zero at its side edge and has at least one minimal value point between said center and side edge.

When the bulk member, sheet member, or cylindrical member is infinitely long in the axial direction, if the applied magnetic field is returned to zero, the magnetization magnetic flux density will become zero at the side edge of the bulk member or sheet member or at the outer surface of the cylinder wall of the cylindrical member, but since a bulk member, sheet member, or cylindrical member actually has a finite length, if the applied magnetic field is returned to zero, an inverse magnetic field effect will occur near the outer circumference. Therefore, here, the magnetization magnetic flux density at the side edge of the bulk member or sheet member or at the outer surface of the cylinder wall of the cylindrical member is made “substantially zero”.

Here, “substantially zero” means that if the sign of the magnetization magnetic flux density is +, it is somewhat −. Further, the absolute value of the deviation from zero is not more than about 10% of the maximum value of the magnetization magnetic flux density quantitatively.

The deviation from zero at the side edge or the outside surface of the cylinder wall is small if compared with the maximum value of the magnetization magnetic flux density, so is made 0 in the view showing the change of the magnetic flux density distribution (FIGS. 1, 2, and 6).

The minimal value points in the distribution of the magnetic flux density component are bending points connected in a close loop in the circumferential direction of the disk or cylinder where the inclination of the magnetic flux from the center of the superconductor to the outer circumference inverts.

If the rate of movement of the magnetic flux is v, on a bending point, v=0, so from E=B×v, |E|=E=0. Here, E is the electric field vector, while B is the magnetic flux density vector.

Therefore, from rotE=−dB/dt, dB/dt=0. The number of magnetic fluxes crossing the closed loop from the bending point to the center is maintained. That is, the change in the magnetic flux is remarkably limited, so the drop in the magnetic flux due to the magnetic flux creep is suppressed.

Therefore, it is possible to obtain a superconductive magnet extremely stable over time, that is, having an extremely constant magnetic flux density along with the elapse of time, aimed at by the present invention.

Here, if the sign of the magnetic flux density of the center is made +, the sign of the minimal value points closest to the side edge inevitably becomes −. So long as the position of a minimal value point is between the center and side edge, it may be at any position, but the closer a minimal value point to the center side, the lower the magnetization magnetic flux density, while the closer to the side edge, the greater the risk of the magnetic flux creep starting to appear even if small in extent. Therefore, a minimal value point is preferably inside at least 1% of the distance between the side edge and center (with circle, radius) at the side edge side from the center point of the center and side edge.

The value of the magnetic flux density magnetized is defined by the Jc-characteristics of the inside of the bulk member or sheet member and the shape factor of the material (various dimensions), but this Jc fluctuates greatly depending on the magnitude B and direction θ of the magnetic flux density vector “B”, so clear definition is difficult.

However, in the case of an actual superconductive material NbTi-multilayer disk, with a radius of 21.5 mm and a thickness of 1 mm (of which, total of thicknesses of NbTi-layers is about 0.35 mm), the magnetic flux density at the center directly above the surface is 0.01 T to 1 T and with a radius of 21.5 mm and a thickness of 10 mm (of which, total of thicknesses of NbTi-layers is about 3.5 mm), the magnetic flux density is 0.05 T to 5T.

Further, for example, when the magnetization magnetic flux density is 1 T and there is a single minimal value point, the magnetic flux density at the minimal value point becomes −0.49 T to −0.005 T.

The bulk member or the sheet member often is circular having a predetermined thickness, but may also be a triangular, quadrangular, pentangular, or other shape. The thickness has to meet the conditions for stably maintaining the superconductive state, but extends over the range from the nm (nanometer) class of thin film to several tens of mm of the bulk member.

The diameter in the case where the bulk member or the sheet member is circular can be selected in a range where production of a circular bulk member or sheet member is possible. When the method of production of a circular bulk member or circular sheet member is a rolling method, it is a maximum 5 m, while when it is the monocrystalline growth method, it is a maximum of 100 mm or so. Note that the diameter can be minimized to about the sub-nanometer size by both methods of production.

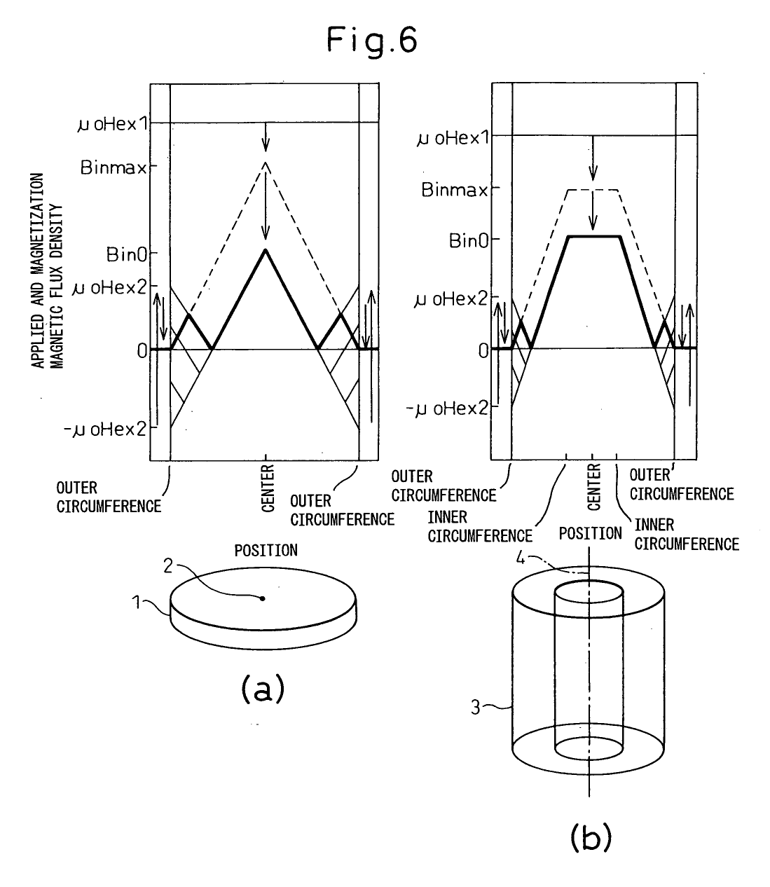

The second aspect of the invention in the present invention provides a superconductive magnet in the first aspect of the invention characterized in that the distribution of said magnetic flux density component has one maximal value point between a minimal value point closest to said side edge of the bulk member or sheet member and said side edge. FIG. 6(a) shows one example of the distribution of the magnetic flux density component.

For the same reason as in the first aspect of the invention, the bending point closest to the side edge (maximal value point) exhibits the effect of preventing new magnetic flux from entering from an outside field, so due to the existence of the maximal value point and minimal value points, it is possible to obtain a superconductive magnet extremely stable over time, that is, having an extremely constant magnetic flux density along with the elapse of time.

Here, if the sign of the magnetic flux density of the center is made +, the sign of the maximal value point inevitably becomes + and the sign of a minimal value point becomes + or − or may also become 0. FIG. 6(a) shows the case where a minimal value point is 0.

The position of a minimal value point in the second aspect of the invention, in the same way as the first aspect of the invention, is preferably inside at least 1% of the distance between the side edge and center (with circle, radius) at the side edge side from the center point of the center and side edge.

The position of the maximal value point should be between a minimal value point and the side edge. Further, for the same reasons, it is preferably inside of at least 1% of the distance between the side edge and center (with circle, radius).

The value of the magnetic flux density magnetized, shape, and dimensions are substantially the same as the case of the first aspect of the invention. The magnetic flux density of a minimal value point is preferably −0.49 T to +0.99 T, while the magnetic flux density of the maximal value point is preferably +0.001 T to +0.99 T.

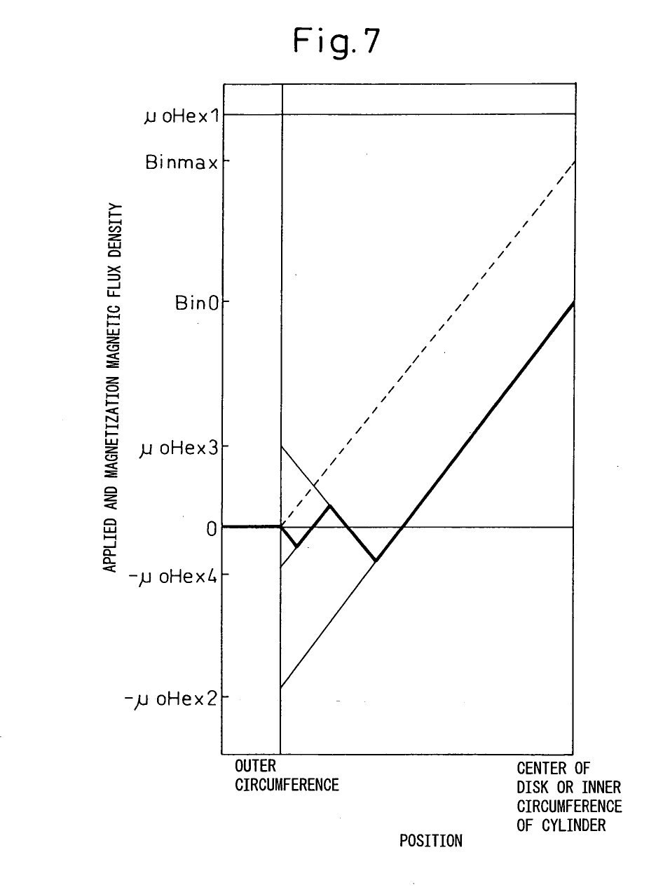

The third aspect of the invention in the present invention provides a superconductive magnet further developed from the first and second aspects of the invention characterized in that, as shown in FIG. 7, the distribution of said magnetic flux density component has (N−1) number of maximal value points and has N number of minimal value points.

For the same reason as in the first and second aspects of the invention, due to the existence of the (2N−1) number of bending points, it is possible to obtain a superconductive magnet extremely stable over time, that is, having an extremely constant magnetic flux density along with the elapse of time.

Here, if the sign of the magnetic flux density of the center is made +, the sign of the minimal value point nearest to the side edge inevitably becomes − and the sign of the other minimal value point and the maximal value points becomes + or − or may also become 0. FIG. 7 shows the case where the sign of a minimal value point is − and the sign of a maximal value point is +.

The bending points closest to the side edge and the center inevitably become the minimal value points, but the position of the minimal value point closest to the center, like in the first aspect of the invention, is preferably inside at least 1% of the distance between the side edge and center (with circle, radius) at the side edge side from the center point of the center and side edge. The position of the minimal value point closest to the side edge is preferably at the side edge side from the minimal value point closest to the center and inside of at least 1% of the distance between the side edge and center (with circle, radius).

The value of the magnetic flux density magnetized, shape, and dimensions are substantially the same as the case of the first aspect of the invention.

The fourth aspect of the invention in the present invention improves on the third aspect of the invention and provides a superconductive magnet characterized by having N number of maximal value points and N number of minimal value points. For the same reason as in the first aspect of the invention in the present invention, due to the existence of the 2N number of bending points, it is possible to obtain a superconductive magnet extremely stable over time, that is, having an extremely constant magnetic flux density along with the elapse of time.

Here, the bending points closest to the side edge inevitably becomes maximal value points and a bending points closest to the center becomes a minimal value point, but if the sign of the magnetic flux density of the center is made +, the sign of the maximal value points nearest to the side edge inevitably becomes + and the sign of the other minimal value points and the maximal value points becomes + or − or may also become 0.

For the same reason as in the second aspect of the invention, the maximal value points closest to the side edge can prevent new magnetic flux from entering from an outside field.

The position of the minimal value point closest to the center, like in the case of the first aspect of the invention, is preferably at the inside by at least 1% of the distance between the side edge and center at the side edge side from the center point of the center and side edge. Further, the position of a maximal value point at the outermost side is preferably at the inside by at least 1% of the distance between the side edge and center (with a circle, the radius) at the side edge side from the minimal value point at the innermost side.

The value of the magnetic flux density magnetized, shape, and dimensions are substantially the same as the case of the first aspect of the invention.

The eighth aspect of the invention in the present invention applies the first aspect of the invention to a seamless cylindrical member of the type II superconductive material. That is, the eighth aspect of the invention provides a superconductive magnet characterized in that a distribution of the magnetic flux density component parallel to the center axis in a plane vertical to the center axis of the cylindrical member has a maximum value at the inside surface of said cylindrical member and is substantially zero at the outside surface and further has at least one minimal value point between said inside surface and outside surface.

FIG. 1(b) shows an example of the magnetic flux density distribution. Due to the existence of the minimal value points, in the same way as the case of the first aspect of the invention, it is possible to obtain a superconductive magnet extremely stable over time, that is, having a magnetic flux density extremely constant along with the elapse of time.

The cylindrical member has a high uniformity of the magnetic flux density at the internal space of the cylinder (part surrounded by inside surface of the cylinder wall), so is suitable for the case of causing a uniform magnetic field in a space larger than a bulk member or sheet member.

Further, in the case of a cylindrical member, a magnetic field parallel to the center axis is generated by a superconductive current flowing in a loop inside the cylinder wall vertical to the center axis, so the cylindrical member has not to include any connections or seams obstructing the characteristics of the zero electrical resistance and flow of the permanent current.

Therefore, the cylindrical member is preferably a seamless cylinder. However, this does not apply if the loop is one-directional and seams are parallel to the loop.

The position of a minimal value point should be between the inside surface and the outside surface of the cylindrical member. However, the closer the position of the minimal value point to the inside surface, the lower the magnetization magnetic flux density. The closer to the outside surface, the greater the risk of the magnetic flux creep starting to appear even if small in extent. Therefore, the position of the minimal value point is preferably at the inside at least 1% of the distance between the outside surface and the inside surface (thickness of cylinder) at the outside surface side from the center point of the inside surface and outside surface of the cylindrical member.

The value of the magnetic flux density magnetized is defined by the Jc-characteristics of the inside of the cylindrical member and the shape factors (various dimensions) of the material, but this Jc fluctuates greatly depending on the magnitude B and direction 0 of the magnetic flux density vector “B”, so clear definition is difficult.

However, in the case of an actual superconductive material NbTi-multilayer cylinder, with an inside diameter of 45 mm, length of 45 mm, and thickness of 1 mm (of which, total of thicknesses of NbTi-layers is about 0.35 mm), the magnetic flux density is 0.01 T to 1 T and with an inside diameter of 45 mm and thickness of 5 mm (of which, total of thicknesses of NbTi-layers is about 3.5 mm), the magnetic flux density is 0.05 T to 5 T.

Further, for example, when the magnetization magnetic flux density is 1 T and there is a single minimal value point, the magnetic flux density at the minimal value point becomes −0.49 T to −0.005 T.

The cylindrical member often is a cylinder having a predetermined thickness, but may also be a cylindrical member of a polyhedron shape such as a triangular, quadrangular, pentangular, or other shape. The cylindrical member is worked using a plastic working method such as typical deep drawing, spinning, and pressing as practical and industrial production processes, but even if the cylindrical member is too thin or thick, working becomes difficult, so the thickness is preferably 0.05 mm to 20 mm or so.

The diameter and length of the cylindrical member can be selected in the producible range, but when using the rolling method as the plastic working method, the size of the sheet before rolling (with disk, diameter) is a maximum 5 m and the diameter is a maximum of about 90% of that. With a small diameter, about 1 mm is also possible. The length is defined by the aspect ratio with the diameter (length/diameter), but about 0.01 to 100 times the diameter is preferable.

The ninth aspect of the invention in the present invention provides the superconductive magnet of the eighth aspect of the invention characterized by having one maximal value point between the minimal value point closest to the outside surface of the cylindrical member and said outside surface. FIG. 6(b) shows an example of the magnetic flux density.

Due to the existence of the maximal value point and minimal value point, for the same reasons as the case of the first aspect of the invention, the bending point closest to the outside surface (maximal value point) exhibits the effect of preventing the entry of new magnetic flux from an outside field, so it is possible to obtain a superconductive magnet extremely stable over time, that is, having an extremely constant magnetic flux density along with the elapse of time, compared even with the eighth aspect of the invention.

Here, if the sign of the magnetic flux density of the inside surface of the cylindrical member is made +, the sign of the maximal value point inevitably becomes + and the sign of the minimal value point becomes + or − or may also become 0. FIG. 6(b) shows the case where the magnetic flux density of the minimal value point is 0.

The position of the minimal value point, like in the case of the first aspect of the invention, is preferably at the inside at least 1% of the distance between the outside surface and inside surface (thickness of cylinder) at the outside surface side from the center point of the inside surface and outside surface of the cylindrical member.

Further, the maximal value point should be between the minimal value point and outer surface of the cylinder, but for the same reasons as the above reasons, it is preferably at the inside at least 1% of the thickness of the cylinder.

The value of the magnetic flux density magnetized, shape of the cylinder, and dimensions are substantially the same as the case of the eighth aspect of the invention. The magnetic flux density of the minimal value point is preferably −0.49 T to +0.99 T, while the magnetic flux density of the maximal value point is preferably +0.001 T to +0.99 T.

The 10th aspect of the invention in the present invention further develops the eighth and ninth aspects of the invention. That is, it provides a superconductive magnet wherein in the cylindrical member of the type II superconductive material, the distribution of said magnetic flux density component inside the cylinder wall, as shown in FIG. 7, has (N−1) number of maximal value points and has N number of minimal value points.

Due to the existence of the (2N−1) number of bending points, it is possible to obtain a superconductive magnet extremely stable over time, that is, having an extremely constant magnetic flux density along with the elapse of time, compared even with the eighth and ninth aspects of the invention.

Here, if the sign of the magnetic flux density of the inside surface of the cylindrical member is made +, the sign of the minimal value point closest to the outside surface inevitably becomes + and the sign of the other minimal value points and the maximal value points becomes + or − or may also become 0. FIG. 7 shows the case where the sign of the minimal value points is − and the sign of the maximal value points is +.

Further, the bending points closest to the outside surface and inside surface of the cylindrical member inevitably become the minimal value points, but the position of the minimal value point closest to the inside surface, like the case of the first aspect of the invention, is preferably at the inside at least 1% of the distance between the outside surface and inside surface (thickness of cylinder) at the outside surface side from the center point of the inside surface and outside surface. Further, the position of the minimal value point closest to the outside surface is preferably at the inside at least 1% of the thickness of the cylinder at the outside surface side from the minimal value point closest to the inside surface. Further, the value of the magnetic flux density magnetized, the shape of the cylinder, and the dimensions are substantially the same as the case of the fifth aspect of the invention.

The 11th aspect of the invention in the present invention improves the 10th aspect of the invention and can provide a superconductive magnet characterized by having N number of maximal value points and N number of minimal value points. For the same reason as the case of the first aspect of the invention, due to the existence of the 2N number of bending points, it is possible to obtain a superconductive magnet extremely stable over time, that is, having an extremely constant magnetic flux density along with the elapse of time.

Here, the bending point closest to the outside surface of the cylindrical member inevitably becomes a maximal value point and the bending point closest to the inside surface becomes a minimal value point. Further, if the sign of the magnetic flux density of the inside surface of the cylindrical member is made +, the sign of the maximal value point nearest to the outside surface inevitably becomes + and the sign of the other minimal value points and the maximal value points becomes + or − or may also become 0.

The position of the minimal value point closest to the inside surface of the cylindrical member, like in the case of the eighth aspect of the invention, is preferably at the inside by at least 1% of the distance between the outside surface and inside surface (thickness of cylinder) at the outside surface side from the center point of the inside surface and outside surface. Further, the position of the maximal value point at the outermost side is preferably at the inside by at least 1% of the thickness of the cylinder at the outside surface side from the minimal value point at the innermost side.

Further, the value of the magnetic flux density magnetized, shape of the cylinder, and dimensions are substantially the same as the case of the eighth aspect of the invention.

The fifth and 12th aspects of the invention in the present invention are superconductive magnets comprised of at least two bulk members, sheet members, or cylindrical members of a type II superconductive material stacked in the thickness direction. The bulk members or sheet members are superconductive magnets having magnetic flux density distributions according to any of the first to fourth aspects of the invention. Further, the cylindrical members are superconductive magnets having magnetic flux density distributions according to any of the eighth to 11th aspects of the invention.

When the bulk members or sheet members are comprised of a superconductive material, in general the magnetization magnetic flux density Bin0 is approximately proportional to the critical current density Jc and its radius R and Bin0=μoJc·R stand. However, this formula corresponds to the case where there is a sufficient thickness in the thickness direction, that is, more precisely, the case of a columnar member having infinite length in the thickness direction.

When the superconductor is thin, the thickness is thin with respect to the radius, so even when placed in a uniform magnetic field, an inverse magnetic field effect where the magnetic flux inverts near the outer circumferential end occurs. The magnetization magnetic flux density shifts downward from this formula. That is, the magnetization magnetic flux density when the superconductor is thin becomes smaller than the value proportional to the radius.

Therefore, to reduce the inverse magnetic field effect and improve the magnetization magnetic flux density, it is important to stack the superconductive bulk members or sheet members in the thickness direction. For example, as described also in the case of the first aspect of the invention, when the aspect ratio (thickness/diameter) is at least 0.5, the above proportional relationship is considerably approached, so if the thickness of the stack is d and the number of stacked layers is N, N·d/(2R)=0.5 becomes a guide to the upper limit of the N number of stacked layers.

It is also possible to increase N beyond this, but the amount of increase of the magnetization magnetic flux density with respect to the increased number of N becomes smaller and the efficiency falls.

In the case of a cylindrical member, stacking concentrically is preferable, but stacking off-center is also possible. If the thickness of the stacked cylindrical members is T and the number of stacked layers is N, the maximum value Binmax of the magnetization magnetic flux density becomes about Binmax=μo∫Jc(B)·dt (integration region 0 to NT), but it is not possible to exceed the upper critical magnetic field Bc₂ of the superconductive material, so the upper limit of N is determined in itself.

Physically, it is possible to increase N above this, but Binmax is saturated, so increasing the N is useless. Further, in the case of a cylindrical member, the length is often sufficiently long compared with the diameter. For example, when the aspect ratio (in the case of a cylinder, the length/diameter) is over 0.5, the effect of the inverse magnetic field effect becomes smaller.

The sixth and 13th aspects of the invention in the present invention are superconductive magnets wherein the bulk members, sheet members, or cylindrical members comprised of type II superconductive material layers and normal conductive material layers alternately stacked and bonded metallically at the stacked boundaries, wherein the bulk members or sheet members are superconductive magnets having magnetic flux density distributions according to any of the first to fourth aspects of the invention or the cylindrical members are superconductive magnets having magnetic flux density distributions according to any of the eighth to 11th aspects of the invention.

By stacking multiple layers of the superconductive material as clad sheets with copper, aluminum, or another high conductivity normal conductive material and metallically bonding the entire surfaces, it is possible to greatly improve the superconductive stability with respect to heat.

For example, if trying to magnetize a disk of a thickness of 1 mm comprised of just the type II superconductive material “Nb-46.5 mass % Ti alloy”, magnetic flux jumps frequently occur in the magnetization and demagnetization process, the superconductive state is destroyed at each time, the normal conductive state ends up being reached, and normal magnetization becomes impossible.

As opposed to this, if cladding copper sheets or aluminum sheets of thicknesses of 1 to several mm as superconductivity stabilizing materials, good magnetization becomes possible when the magnetization and demagnetization rate becomes extremely slow.

To enable good magnetization even if making the magnetization and demagnetization rate larger, it is preferable to make the thickness of the NbTi-alloy layers 1 to 100 μm and increase the number of layers and to alternately stack and clad 1 to 100 μm copper layers or aluminum layers.

Here, when the thickness and the number of stacked layers of the NbTi-alloy layers are Tsc and Nsc and the thickness and the number of stacked layers of the copper layers or aluminum layers are Tnc and Nnc, (Nnc·Tnc)/(Nsc·Tsc) becomes the value showing the stability of the superconductivity called the “copper ratio”.

The higher the value, the more improved the stability of the superconductivity, but the overall current density falls, so this value (copper ratio) is preferably 0.5 to 1.0.

A range where this value is low is preferable when seeking a high current density in an environment where the superconductivity is stable. On the other hand, a range where this value is high is preferable when the stability of the superconductivity is poor, but even a low current density is sufficient.

The seventh and 14th aspects of the invention in the present invention are superconductive magnets wherein in the bulk member, sheet member, or cylindrical member comprised of the type II superconductive material layers and the normal conductive material layers alternately stacked together, the stacked boundaries have diffusion barrier layers and are metallically bonded.

This diffusion barrier layer is for example the Nb in an NbTi/Nb/Cu-multilayer clad sheet. When trying to get thermal hysteresis during working, Ti diffuses into the Cu at the boundaries between the NbTi and Cu, brittle intermetallic compounds such as Ti₂Cu are produced, and the workability greatly falls. To prevent a large drop in the workability, Nb is used as a diffusion barrier and sandwiched at the stacked boundaries of the NbTi and Cu.

According to this method, the high critical current density of the NbTi is not lowered. Further, it is possible to prevent deterioration of the superconductive stability due to the purity of the Cu falling and the resistance rising.

As the material of the diffusion barrier, the high melting point Nb, Ta, etc. are preferable. The thickness of the diffusion barrier should exceed the diffusion distance of the atoms covered by the prevention of diffusion (in the above, Ti or Cu), but is preferably as thin as possible or about 0.01 μm to 10 μm in a range not posing a problem in material and production cost.

The 15th aspect of the invention in the present invention is a superconductive magnet wherein the type II superconductive material is any one of an NbTi-based alloy, Nb₃Sn, V₃Ga, and oxide-based superconductive material and said normal conductive material is at least one type of material among copper, a copper alloy, aluminum, or an aluminum alloy.

The NbTi-based alloy, Nb₃Sn, and V₃Ga have a Jc in a high magnetic field of about several T of over 100,000 A/cm² and are able to sufficiently handle the needs of actual superconductive materials.

The normal conductive member is preferably as high a conductivity as possible from the viewpoint of the stability of the superconductivity and is selected from the viewpoint of the workability after cladding with the superconductive material.

The 16th aspect of the invention in the present invention is a superconductive magnet where the type II superconductive material is a Y—Ba—Ca—Cu—O based oxide superconductive material or a Bi—Sr—Ca—Cu—O based oxide superconductive material.

These superconductive materials have a Tc higher than the boiling point of liquid nitrogen, that is, 77 K, so it is possible to secure a current density sought in the applications of the present invention even in an environment of use at a higher temperature than the temperature of use of the superconductive material in the 15th aspect of the invention.

The 17th aspect of the invention in the present invention is a method of production of a superconductive magnet comprising stacking N number of bulk members, sheet members, or cylindrical members of type II superconductive materials in the thickness direction.

When the bulk members or sheet members have anistropy of the critical current density (Jc-anistropy) according to the direction in the plane, when stacking at least N number of bulk members or sheet members in the thickness direction, the anistropy is eased by stacking them shifted in angle by (180/N)° each.

The Jc-anistropy is often due to the anistropy of the microstructure or macroshape of the type II superconductive material. For example, in the case of an NbTi/Nb/Cu-multilayer clad superconductive sheet fabricated by the rolling method, there is anistropy of the critical current density between the direction parallel to and the direction vertical to the rolling direction. In general, the critical current density in the direction vertical to the rolling direction is somewhat higher than the critical current density in the direction parallel to the rolling direction.

This is due to the fact that the shape of the micro α-Ti phase precipitate having the effect of improving the critical current density is elongated by the rolling and becomes elongated.

Therefore, if stacking in the thickness direction while aligning the rolling direction in the same direction, the anistropy of the critical current density is held as it is in the thickness direction, so anistropy of the magnetization magnetic flux density ends up occurring. To prevent this, it is preferable to stack the superconductive materials showing the rolling direction shifted in angle of the rolling direction.

Further, when the cylindrical member has anistropy of the critical current density with respect to the circumferential direction about the center axis of the cylinder, the anistropy is eased by stacking while shifting the angle.

The reason for the occurrence of the anistropy of the critical current density in a cylindrical member is that for example in the case of a seamless superconductive cylinder fabricated by the deep drawing method from an NbTi/Nb/Cu-multilayer clad superconductive sheet, the anistropy of the critical current density due to the rolling direction remains even after the deep drawing. As a result, anistropy of the magnetization magnetic flux density ends up occurring.

Therefore, it is preferable to display the rolling direction before the deep drawing and stack in the thickness direction while shifting the angle of the rolling direction. Further, the method of stacking is preferably concentric, but offset is also possible.

The method of shifting the angle in the stacking of the bulk members, sheet members, or cylindrical members is to shift two 90° each, shift four 45° each, shift six 30° each, and otherwise shift by a total of 180°. To obtain a more isotropic magnetization magnetic flux density, it is preferable to reduce the angle of shift.

The 18th aspect of the invention in the present invention is a magnetization method according to the first to 17th aspects of the invention. As shown in FIG. 1, this comprises holding a superconductor comprised of a bulk member, sheet member (disk shape in FIG. 1(a)), or cylindrical member (cylinder in FIG. 1(b)) of a type II superconductive material at a temperature higher than the critical temperature Tc, for example, room temperature, to set it in a normal conductive state, setting it near a magnetic field generation system enabling control of the generated magnetic field by an external power supply, for example, a superconductive magnet comprised of a coil of a wound superconductive wire material (hereinafter referred to as a “superconductive magnet”) or a normal conductive magnet, applying a magnetic field Hex1 [A/m] to the superconductor, running a magnetic flux density μoHex1 through it, then cooling to place the superconductor in the superconductive state and making the magnetic flux run through it be trapped by the superconductor.

Next, it comprises reducing the applied magnetic field, applying a magnetic field until −Hex2 (magnetic flux density of −μoHex2, where Hex1>0, Hex2>0) in the opposite direction as the trapped magnetic flux, reducing the trapped magnetic flux density to Bin0[T], then again returning the applied magnetic field to zero to end the magnetization.

By this method, magnetization is possible so as to obtain the magnetic flux density distribution shown by the bold line in FIG. 1(a) on the surface of the bulk member or sheet member and magnetization is possible so as to obtain the magnetic flux density distribution shown by the bold line in FIG. 1(b) in the internal space of the cylindrical member.

In the case of an actual superconductive material NbTi-multilayer disk, Bin0 is 0.01 T to 1 T in terms of the Binmax in the case of a radius of 21.5 mm and thickness of 1 mm (of which the total of the thicknesses of the NbTi-layers is about 0.35 mm) or 0.05 T to 5 T in terms of the Binmax in the case of a radius of 21.5 mm and a thickness of 10 mm (of which the total of the thicknesses of the NbTi-layers is about 3.5 mm).

In this case, μoHex1 should be higher than Binmax and is preferably about 5% to 30% higher. Further, μoHex2 should be smaller than μoHex1, but if too large in the small range, the magnetization magnetic flux density Bin0 ends up becoming excessively small. Further, if too small in the small range, the risk increases of the effect of suppression of the magnetic flux creep becoming small. Therefore, it is preferable that
0.01Binmax≦μoHex2≦0.5Binmax.

Further, in the case of an NbTi-multilayer cylinder, Bin0 is 0.01 T to 1 T in terms of the Binmax in the case of an inside diameter of 45 mm, a length of 45 mm, and a thickness of 1 mm (of which the total of the thicknesses of the NbTi layers is about 0.35 mm) or 0.05 T to 5 T in terms of the Binmax in the case of an inside diameter of 45 mm and a thickness of 5 mm (of which the total of the thicknesses of the NbTi-layers is about 3.5 mm).

In this case as well, μoHex1 should be higher than Binmax and is preferably about 5% to 30% higher. Further, μoHex2 should be smaller than μoHex1, but if too large in the small range, the magnetization magnetic flux density Bin0 ends up becoming excessively small. Further, if too small in the small range, the risk increases of the effect of suppression of the magnetic flux creep becoming small. Therefore, it is preferable that 0.01Binmax≦μoHex2≦0.5Binmax. In this case, Bin0 becomes 0.01Binmax≦μoHex2≦0.5Binmax.

Here, when μoHex1≧Binmax, Bin0≅Binmax−μoHex2
when μoHex1<Binmax, Bin0<Binmax−μoHex2
   stand. Here, μo is the magnetic permeability in a vacuum, but is substantially the same as the magnetic permeability in the air.

Binmax shows the maximum magnetic flux density which a superconductive bulk member, sheet member, or cylindrical member can trap at any temperature lower than the critical temperature Tc when monotonously reducing the external applied magnetic field to zero. As shown in FIG. 2(a) and (b), it is equal to the maximum trapped magnetic flux density in the case of no bend in the inclined parts of the magnetic flux density.

When separating the magnetized superconductive magnet and magnetic field generation system, it is possible to fix at least one and separate the other. It is also possible to move and separate the two. Further, it is possible to not separate the magnetization magnetic field generation system and leave it where it is set.

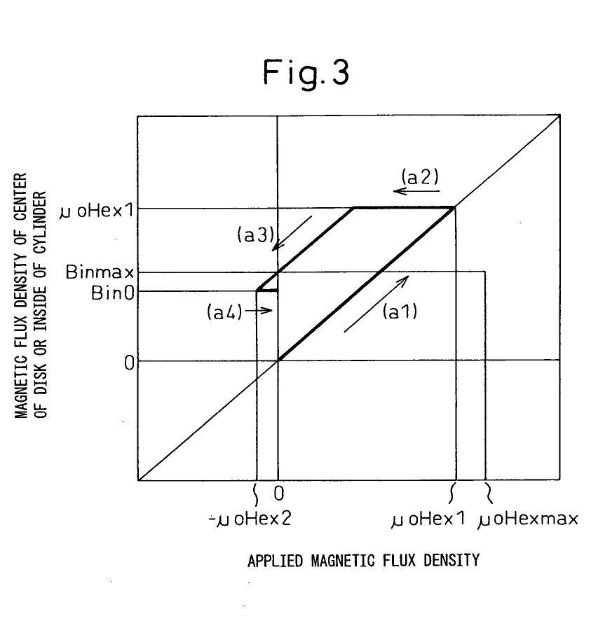

FIG. 3 shows the relationship between the externally applied magnetic field Hex and the internal magnetic flux density Bin of the superconductor in the process of magnetization by the magnetization method of the present invention. FIG. 3 is a view of the above relationship when raising Hex until μoHex1≧Binmax. At this time, Bin0≅Binmax−μoHex2. The magnetic flux density approximately substantially equal to the difference from μoHex2 demagnetized to the minus side from the maximum magnetic flux density Binmax able to be magnetized when reducing the externally applied magnetic field to zero is trapped.

(a1) in FIG. 3 shows the process of raising the externally applied magnetic field to Hex1 in the normal conductive state, (a2) shows the process of cooling to the superconductive state, then demagnetizing, where the magnetic field μoHex1 still continues to be partially trapped mainly at the center, and (a3) shows the process of continuing the demagnetization to pass the zero magnetic field, changing the applied magnetic field in the reverse direction as the trapped magnetic flux and applying it to −Hex2, whereby the trapped magnetic flux density at the center falls.

(a4) shows the process of returning from −Hex2 to a zero magnetic field to end the magnetization, but in this process, the trapped magnetic flux density Bin0 is constant and does not change. Further, the result of magnetization by the process of FIG. 3 becomes as shown in FIG. 1.

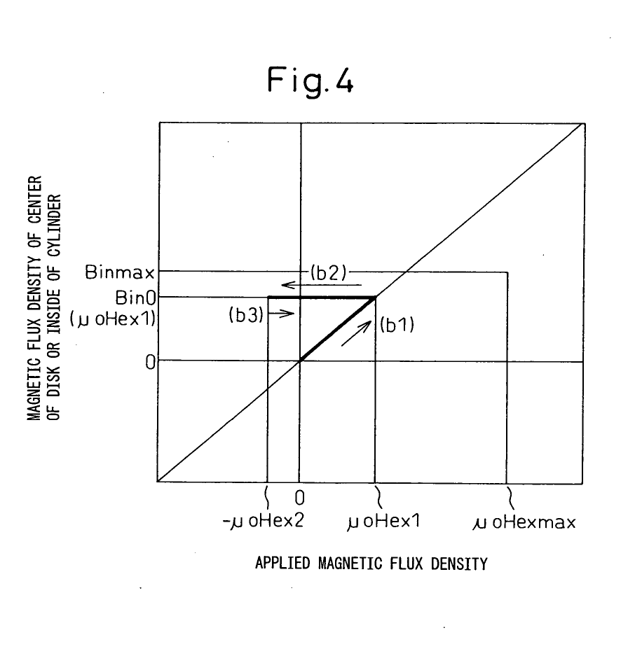

FIG. 4 is a view of the above relationship when magnetizing so that μoHex1 does not exceed Binmax−μoHex2 where μoHex2≦Binmax−μoHex2. During demagnetizing to a zero magnetic field and finishing magnetization, the trapped magnetic flux density Bin0 is constant and does not change.

(b1) in FIG. 4 shows the process of raising the externally applied magnetic field to Hex1 in the normal conductive state so as not to exceed the maximum trapped magnetic flux density Binmax, (b2) shows the process of cooling to the superconductive state, then demagnetizing to a zero magnetic field, passing the zero magnetic field, changing the applied magnetic field to the reverse direction of the trapped magnetic flux, and magnetizing to −Hex2, during which the magnetic flux density μoHex1 (equal to Bin0) continues to be partially trapped, and (b3) shows the process of returning the applied magnetic field to zero to end the magnetization, during which the trapped magnetic flux density Bin0 is constant and does not change.

This magnetization hysteresis appears in the case of μo(Hex1+Hex2)≦Binmax.

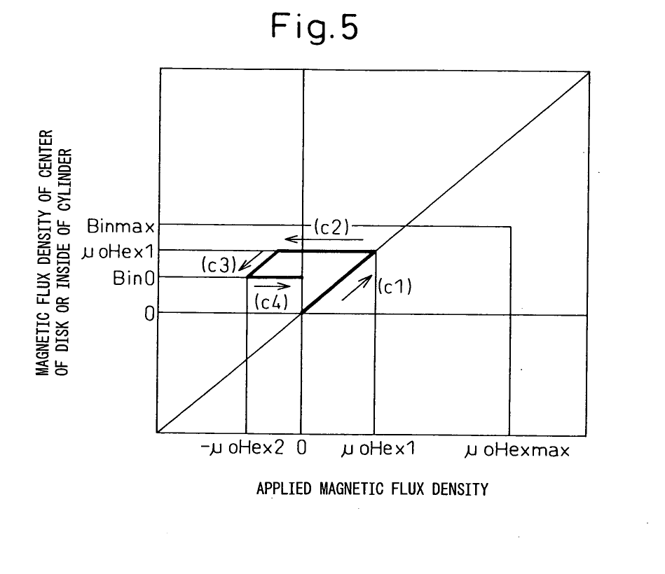

FIG. 5 is a view of the relationship between an externally applied magnetic flux density and internal magnetic flux density when magnetizing so that μoHex1 exceeds Binmax−μoHex2, but does not exceed Binmax where Binmax−μoHex2<μoHex1≦Binmax. When demagnetizing to a zero magnetic field and then further magnetizing in the reverse direction to the trapped magnetic flux, the magnetic flux density μoHex1 which had continued to be trapped in part starts to be reduced, but Bin0 is constant and does not change from the applied magnetic field −Hex2 to returning to zero again.

(c1) in FIG. 5 shows the process of raising the externally applied magnetic field to Hex1 in the normal conductive state, (c2) shows the process of cooling to the superconductive state, then demagnetizing to a zero magnetic field, passing the zero magnetic field, and changing the applied magnetic field to the reverse direction of the trapped magnetic flux, during which the magnetic flux density μoHex1 before reaching −Hex2 continues to be partially trapped, (c3) shows the process of applying a magnetic field at −Hex2 in the opposite direction as the trapped magnetic flux, where the trapped magnetic flux density μoHex1 falls to Bin0, and (c4) shows the process of returning to zero to end the magnetization, during which the trapped magnetic flux density Bin0 is constant and does not change.

This magnetization hysteresis appears in the case of μo(Hex1+Hex2)>Binmax.

According to the magnetization method of the present invention, it is possible to raise the externally applied magnetic field to Hex1, then cool the superconductor to below the critical temperature and trap the magnetic flux, so if the magnetization system is a normal conductive magnet, a heater or other temperature control system is not required.

When the magnetization system is a superconductive magnet, if storing conventional superconductive magnets and the new superconductive magnets in separate cryostats (cooling temperature holding tanks), no heater etc. is required.

In the unlikely event of storing the conventional superconductive magnets and new superconductive magnets together in a single cryostat, they will end up being simultaneously cooled if there is no heater, so in this case, it is necessary to heat the new superconductive magnets by a heater or other temperature control system.

The 19th aspect of the invention in the present invention, as shown in FIG. 6, provides a magnetization method of a superconductive magnet of the 18th aspect of the invention trapping the magnetic flux density Bin0 by applying a magnetic field −Hex2 (magnetic flux density −μoHex2) in the opposite direction to the trapped magnetic flux, then reversing it to a direction the same as the trapped magnetic field and applying a magnetic field until +Hex3 (in FIG. 6, Hex3=Hex2), then returning to a zero magnetic field to complete the magnetization.

By this magnetization method, it is possible to form magnetic flux density distributions as shown in FIG. 6(a) on the surface of the bulk member or sheet member or as shown in FIG. 6(b) in the inside space of the cylinder member.

According to the magnetization method of the present invention, it is possible to increase the number of bending points of the magnetic flux density to two locations at the outskirts of the trapped magnetic flux density distribution. Further, according to the magnetization method of the present invention, it is possible to form maximal value points at the outermost sides and prevent entry of magnetic flux from an outside field and possible to further strengthen the suppression of magnetic flux creep. That is, according to the 19th aspect of the invention, the rate of drop of the magnetic flux density is further reduced compared with the case of the 18th aspect of the invention.

The 20th aspect of the invention in the present invention, as shown in FIG. 7, comprises the 18th aspect of the invention further applying a magnetic field −Hex2 in the opposite direction as the trapped magnetic flux (magnetic flux density−μoHex2), then reversing the magnetic field to the same direction as the trapped magnetic flux and applying it up to +Hex3, then again reversing the magnetic field to the opposite direction of the trapped magnetic flux and applying it up to −Hex4 (Hex2>0, Hex3>0, Hex4>0) by inverting the direction of the applied magnetic field while applying a magnetic field to Hex(2N−1) or Hex(2N) (Hex(2N−1)>0, Hex(2N)>0, N=1, 2 . . . , n), then return to a zero magnetic field to complete the magnetization.

Due to this magnetization method, it is possible to form a distribution of magnetic flux density as shown by the bold line in FIG. 7 on the surface of the bulk member or sheet member or at the inside space of the cylindrical member.

Due to the magnetization method of the present invention, it is possible to increase to (2N−1) or 2N the number of bending points of the magnetic flux density at the outskirts of the distribution of trapped magnetic flux density. Due to this increase, it is possible to further strengthen the degree of suppression of magnetic flux creep.

That is, in the 20th aspect of the invention, the rate of drop in the magnetic flux density is further reduced compared with the case of the 18th and 19th aspects of the invention.

Even when there are (2N−1) number or 2N number of bending points, the bending point at the innermost side inevitably becomes a minimal value point. The bending points at the outermost sides become minimal value points when (2N−1) and maximal value points when 2N.

### EXAMPLES

### Example 1

The drop in the magnetic flux density trapped by a type II superconductive material due to magnetic flux creep was measured by conducting the following experiment. First, a type II superconductive material “Nb-46.5 mass % Ti alloy” and a stabilizing material 4-Nine pure copper were used to fabricate a multilayer clad sheet by the following method of production.

Thirty layers of NbTi of thicknesses of about 12 μm and 29 layers of Cu of the same thicknesses were alternately stacked, Cu layers of about 10 times those thicknesses were stacked at the outermost layers, and Nb layers of thicknesses of 1 μm were inserted as diffusion barriers at the stacking boundaries of these metal layers to obtain a multilayer clad sheet of a thickness of 1 mm.

One superconductive multilayer disk of a diameter of 43 mm was taken from this sheet and arranged in a bore of a solenoid type superconductive magnet. The superconductive magnet was immersed in liquid helium. The superconductive multilayer disk arranged in the bore of the superconductive magnet was held at 4.2 K and became a superconductive state if not heated by a heater etc.

The temperature was measured by attaching a superlow temperature use temperature sensor to the surface of the superconductive multilayer disk. Further, the magnetic flux density trapped by the superconductive multilayer disk was measured by arranging a Hall element at the center right above the surface.

First, a heater brought into contact with the superconductive multilayer disk was used to heat the superconductive multilayer disk to at least the critical temperature, a superconductive magnet was used to apply a magnetic field to give an applied magnetic flux density (hereinafter referred to as an “applied magnetic field”) of 1 T, then the heater was turned off to make the temperature 4.2 K to make the superconductive magnet a superconductive state, then the applied magnetic field was reduced.

At the start of the demagnetization process, the trapped magnetic flux density did not change at 1 T, but when the applied magnetic field was reduced to 0.4 T, the trapped magnetic flux density also started to fall. When the applied magnetic field became zero, the density became 0.6 T (Binmax) right above the surface.

Therefore, when the applied magnetic field was applied up to −0.2 T in the reverse direction to the trapped magnetic flux, the trapped magnetic flux density became 0.4 T at the center right above the surface.

Next, when the applied magnetic field was returned to zero and the magnetization was ended, the trapped magnetic flux density did not change until 0.4 T (Bin0).

Further, at this time, the Hall element right above the disk was made to move from the center to the end in the radial direction. While doing this, the magnetic flux density distribution was measured, whereby a magnetic flux density distribution of the shape shown in FIG. 1(a) was substantially obtained.

Here, the minimal value point is present at a distance from the center near 18 mm or about 5/6 of the diameter of the disk. Further, the magnetic flux density was −0.105 T.

Therefore, the change along with time of the trapped magnetic flux density due to magnetic flux creep was measured at the center right above the surface of the superconductive magnet until 2100 seconds from right after the end of the magnetization. Note that in this case the trapped magnetic flux density using the magnetization method of the present invention was measured by the NMR method (detection of the fluctuations in the magnetic field due to the nuclear magnetic resonance method) since the measurement accuracy is insufficient with a Hall element.

For comparison, magnetization was performed by the conventional method. In the same way as the above, a magnetic field was applied until 1 T, then the applied magnetic field was reduced to zero. The magnetization was ended when the magnetic flux density of the center became 0.6 T. The measurement of the magnetic flux creep was started from that point.

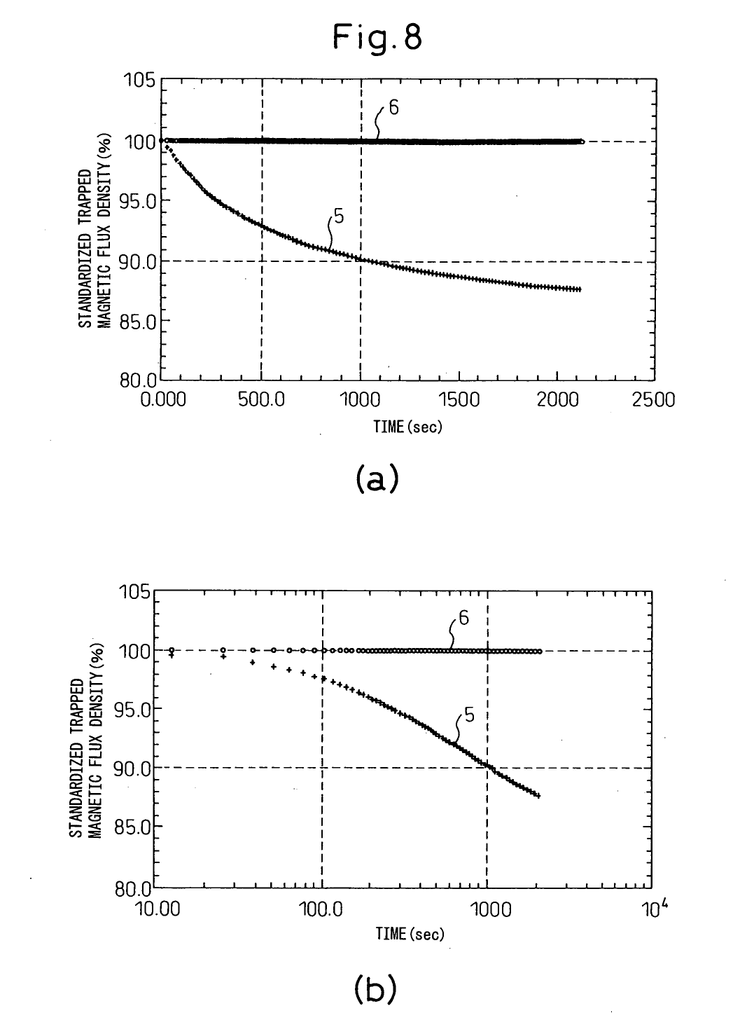

The change along with time of the trapped magnetic flux density of the superconductive magnet is shown in FIG. 8. As shown in the figure, in the prior art, the rate of reduction of the trapped magnetic flux density after 2100 seconds when making the trapped magnetic flux density at the time of the start of measurement 100% was about 12% (in the figure, see the curve 5), while with the magnetization method of the present invention, it could be suppressed to about 3 ppm (in the figure, see the curve 6).

Further, a disk taken from this multilayer clad sheet was deep drawn and spun to obtain a seamless cylinder having a thicknesses of 1 mm, an inside diameter of 43 mm, and a length of 45 mm. In the same way as the case of the disk, a magnetization experiment and a magnetic flux creep measurement experiment were conducted.

The magnetization magnetic flux density and the magnetic flux creep were measured by measurement values of a Hall element arranged at the axial center or the NMR method which were used instead of the magnetic flux density of the cylinder inside surface.

The position of the minimal value point was calculated by measuring the magnetic flux density distribution by Hall elements suitably arranged at the inside and outside of the cylinder, acquiring the Jc-characteristics of the superconductive cylinder measured in advance (including the magnetic flux density distribution B dependency and the angular dependency formed by the B vector and the NbTi layer) for electromagnetic field numerical analysis, simulating the current distribution in the superconductive material, and calculating the magnetic flux density distribution in the superconductive cylinder.

Hall elements were arranged in the radial direction of the cylinder at four locations, that is, on the axial center and at positions of 9 mm and 18 mm (up to here, inside the cylinder) and a position of 25 mm (outside the cylinder) in the radial direction from the center. The Hall element support jigs were made to move in parallel to the axial direction and measurements were conducted at a total of 20 points of 0 mm, 9 mm, 18 mm, 27 mm, and 36 mm from the center.

As a result, the magnetic flux density distribution in the radial direction at the inside of the superconductive cylinder and in the thickness direction of the inside of the cylinder shown in FIG. 1(b) was obtained. Further, the minimal value point was near 0.85 mm from the inside surface of the cylinder to the outside surface of the cylinder and had a magnetic flux density of −0.102 T.

In the conventional method, the trapped magnetic field density (Bin0) at the start of measurement was 0.6 T. Further, the rate of reduction of the trapped magnetic flux density after 1800 seconds when making 0.6 T 100%. As opposed to this, with the magnetization method of the present invention, Bin0 fell to 0.4 T. The rate of reduction for this could be suppressed to about 3 ppm.

### Example 2

A disk having a thickness of 1 mm and a diameter of 43 mm was taken from a multilayer clad sheet the same as Example 1. The same procedure was followed as in Example 1 to measure the change along with time of the temperature and the trapped magnetic flux density. While doing this, the disk was magnetized as follows:

The multilayer clad sheet was magnetized in the same way as Example 1 and the applied magnetic field was reduced, then a magnetic field was applied across zero in the same direction as the trapped magnetic flux until +0.2 T (+μoHex2), then the applied magnetic field was returned again to zero to complete the magnetization.

During this time, the trapped magnetic flux density did not change until 0.4 T (Bin0). Further, at this time, the Hall element directly above the disk was made to move in the radial direction from the center to the end and the magnetic flux density distribution was measured, whereupon the magnetic flux density distribution as shown in FIG. 6(a) was obtained.

Here, the minimal value point was near 14.5 mm from the center or corresponding to about 2/3 of the disk radius and had a magnetic flux density of 0.005 T. Further, the maximal value point was near 18.1 mm from the center and had a magnetic flux density of 0.095 T.

Next, the change along with time of the trapped magnetic flux density due to the magnetic flux creep was measured until 2100 seconds from right after the end of the magnetization. According to the results, in the magnetization method of the present invention, the rate of reduction of the trapped magnetic flux density after 2100 seconds when making the trapped magnetic flux density at the time of start of measurement 100% could be suppressed to about 2 ppm.

Further, a disk taken from this multilayer clad sheet was deep drawn and spun to obtain a seamless cylinder having a thicknesses of 1 mm, an inside diameter of 43 mm, and a length of 45 mm. In the same way as the case of the disk, a magnetization experiment and a magnetic flux creep measurement experiment were conducted.

The magnetization magnetic flux density and the magnetic flux creep were measured by measurement values of a Hall element arranged at the axial center which were used instead of the magnetic flux density of the cylinder inside surface. The position of the minimal value point at the inside of the superconductive cylinder was calculated by the same method as in Example 1.

As a result, the magnetic flux density distribution in the radial direction at the inside of the superconductive cylinder and in the thickness direction at the inside of the cylinder was the magnetic flux density distribution substantially such as shown in FIG. 6(b).

Here, the minimal value point was near 0.68 mm from the inside surface of the cylinder to the direction of the outside surface of the cylinder and had a magnetic flux density of 0.07 T. Further, the maximal value point was near 0.85 mm from the center and had a magnetic flux density of 0.103 T.

According to these results, in the magnetization method of the present invention, it was possible to suppress the rate of reduction of the trapped magnetic flux density after 1800 seconds when making the trapped magnetic flux density at the time of start of measurement 100% to about 2 ppm.

### Example 3

A disk having a thickness of 1 mm and a diameter of 43 mm was taken from a multilayer clad sheet the same as Example 1. The same procedure was followed as in Example 1 to measure the change along with time of the temperature and the trapped magnetic flux density. While doing this, the disk was magnetized as follows:

First, the multilayer clad sheet was magnetized in the same way as Example 1, then a magnetic field was applied in the same direction as the trapped magnetic flux up to +0.15 T (+μoHex3), then the applied magnetic field was reduced one more time to zero, then a magnetic field was applied in the opposite direction to the trapped magnetic flux until −0.1 T (−μoHex4), then finally was reduced to zero to complete the magnetization.

During this time, the trapped magnetic flux density did not change until 0.4 T (Bin0). Further, at this time, the Hall element directly above the disk was made to move in the radial direction from the center to the end and the magnetic flux density distribution was measured. As a result, a magnetic flux density distribution of the shape as shown in FIG. 7 was obtained.

Here, the minimal value point nearest to the center was a distance of 15.4 mm from the center and had a magnetic flux density of −0.026 T. The adjoining maximal value point was near 16.3 mm from the center and had a magnetic flux density of +0.002 T. The minimal value point nearest the side edge was near 18.9 mm from the center and had a magnetic flux density of −0.05 T.

Next, the change along with time of the trapped magnetic flux density due to the magnetic flux creep was measured until 2100 seconds from right after the end of the magnetization. According to the results, in the magnetization method of the present invention, the rate of reduction of the trapped magnetic flux density after 2100 seconds when making the trapped magnetic flux density at the time of start of measurement 100% could be suppressed to about 1 ppm.

Further, a disk taken from this multilayer clad sheet was deep drawn and spun to obtain a seamless cylinder having a thicknesses of 1 mm, an inside diameter of 43 mm, and a length of 45 mm. In the same way as the case of the disk, a magnetization experiment was conducted.

Here, the minimal value point closest to the inside surface of the cylinder was a distance near 0.7 mm from the inside surface of the cylinder to the direction of the outside surface of the cylinder and had a magnetic flux density of −0.025 T. Further, the adjoining maximal value point was near 0.7 mm from the inside surface of the cylinder to the outside surface of the cylinder and had a magnetic flux density of −0.003 T. The minimal value point closest to the side edge was near 0.9 mm from the inside surface of the cylinder to the direction of the outside surface of the cylinder and had a magnetic flux density of −0.053 T.

According to these results, in the magnetization method of the present invention, it was possible to suppress the rate of reduction of the drop in the trapped magnetic flux density after 1800 seconds when making the trapped magnetic flux density at the time of start of measurement 100% to about 1 ppm.

### Example 4

Four disks having thicknesses of 1 mm and diameters of 43 mm were taken from a multilayer clad sheet the same as Example 1. The four were stacked in the thickness direction. The same procedure was followed as in Example 1 to measure the change along with time of the temperature and the trapped magnetic flux density. While doing this, the disks were magnetized in the same way as in Example 1 to change the values of Hex1 and Hex2 as follows:

When making μoHex1 3 T and making −μoHex2-0.5 T, Binmax became 1.9 T.

The magnetic flux density distribution in the thickness direction was the same as the magnetic flux density distribution shown in FIG. 1(a). Here, the minimal value point was at a distance from the center near 19.2 mm and had a magnetic flux density of −0.25 T. According to the magnetization method of the present invention, the rate of reduction of the drop in the magnetic flux density due to the magnetic flux creep from right after the end of the magnetization became substantially the same degree as the case of Example 1, but it was possible to improve the Bin0 to 1.6 T or 2.7 times.

### Example 5

Four seamless cylinders having thicknesses of 1 mm, inside diameters of 43 mm, 41.5 mm, 40 mm, and 38.5 mm, and heights of 45 mm were fabricated from a multilayer clad sheet the same as Example 1. The four were stacked concentrically in the thickness direction. The same procedure was followed as in Example 1 to measure the change along with time of the temperature and the trapped magnetic flux density. While doing this, the cylinders were magnetized in the same way as in Example 1 to change the values of Hex1 and Hex2 as follows:

When making μoHex1 4 T and making −μoHex2 −0.6 T, Binmax became 2.4 T.

The magnetic flux density distribution in the thickness direction was the same as the magnetic flux density distribution shown in FIG. 1(b). Here, the minimal value point was at a distance from the cylinder inside surface near 3.6 mm and the magnetic flux density was −0.30 T. According to the magnetization method of the present invention, the rate of reduction of the drop in the magnetic flux density due to the magnetic flux creep from right after the end of the magnetization became substantially the same degree as the case of Example 1, but it was possible to improve the Bin0to 1.8 T or 4.5 times.

### Example 6

A multilayer clad sheet the same as Example 1 was measured for the critical current density Jc in the two directions of the direction parallel to the rolling direction (hereinafter the “L direction”) and the direction vertical to it (“C direction”). The JC was measured by the four terminal method by cutting out an elongated sample of a width of 0.5 mm and a length of 50 mm from the sheet.

When the Jc was measured for every other 1 T in the range of a magnetic flux density applied from the outside of 1 T to 6 T, the Jc in the C direction became about 20% to 25% larger than the Jc in the L direction for all applied magnetic flux densities.

Therefore, four disks were stacked in the thickness direction while changing the angle by 90 degree each from the rolling direction. The same procedure was followed as in Example 1 to measure the change along with time of the temperature and the trapped magnetic flux density while doing this, the same magnetization experiment as in Example 1 was performed.

At the topmost disk, the magnetization magnetic flux density was measured for 19 points separated by 5 degrees each (5 degrees, 10 degrees, 15 degrees, . . . , 85 degrees, and 90 degrees) in the circumferential direction from the rolling direction on a circle of a radius of 10 mm.

The difference between the maximum and minimum magnetic flux density was about 25% in the case of a single disk, but was reduced to about 10% when stacking four disks changed in angle.

Further, it was reduced to about 5% when stacking four disks in the thickness direction while changing the angle by 45 degrees each from the rolling direction.

### Example 7

Disks taken from a multilayer clad sheet the same as in Example 1 were deep drawn and spun to obtain four seamless cylinders having thicknesses of 1 mm, inside diameters of 43 mm, 41.5 mm, 40 mm, and 38.5 mm, and heights of 45 mm.

The rolling directions (0 degrees) of the ends of the cylinders were marked and the four cylinders were stacked concentrically in the thickness direction while changing the angles 90 degrees each. The same procedure was followed as in Example 1 to measure the change along with time of the temperature and the trapped magnetic flux density. While doing this, a magnetization experiment was conducted in the same way as in Example 1.

At the outermost cylinder, the magnetization magnetic flux density was measured by a Hall element for 10 points separated 5 degrees (5 degrees, 10 degrees, 15 degrees, . . . 85 degrees, 90 degrees) each in the circumferential direction from the rolling direction on a circle of a radius of 10 mm.

The difference between the maximum and minimum was about 20% in the case of a single cylinder, but was reduced to about 8% when stacking four cylinders changed in angle. Further, it was reduced to about 4% when stacking four cylinders in the thickness direction while changing the angle by 45 degrees each from the rolling direction.

### Example 8

As the type II superconductive material, an “Nb-46.5 masst%Ti alloy” was selected and cold rolled to a sheet of a thickness of 0.36 mm. A disk of a diameter of 43 mm was cut out from it. The same procedure was followed as in Example 1 to measure the change along with time of the temperature and trapped magnetic flux density. While doing this, the disk was attempted to be magnetized in the same way as in Example 1.

As a result, there were frequent magnetic flux jumps. Each time, the superconductive state was destroyed and the normal conductive state resulted. Normal magnetization was impossible.

As opposed to this, two 4-Nine pure copper disks of thicknesses of 0.32 mm were soldered and press-bonded to the top and bottom of the NbTi-alloy sheet as superconductivity stabilizing materials to attempt magnetization in the same way as in Example 1.

As a result, good magnetization results were obtained under slow conditions of a magnetization and demagnetization rate of 0.15 T/min. This was an improvement over the case of just the NbTi-alloy sheet, but when the magnetization and demagnetization rate became larger, magnetic flux jumps again occurred and the superconductive state was destroyed.

As opposed to this, 30 sheets of NbTi-alloy foil of thicknesses of 12 μm were stacked alternately with 29 steel sheets of the same thickness, two copper sheets of thicknesses of 0.12 mm were stacked at the outermost layers, and the CIP method was used for cladding. The result was subjected to a similar magnetization experiment.

As a result, magnetic flux jumps did not occur even with a magnetization and demagnetization rate of 1 T/min. Even when using aluminum sheets instead of copper sheets, substantially the same results were obtained.

### Example 9

Except for making the type II superconductive material Nb₃Sn and V₃Ga or making the normal conductive material copper, the same procedure was followed as in Example 1 to measure the change along with time of the temperature and the trapped magnetic flux density. While doing this, the same procedure was followed as in Example 1 for magnetization.

The rate of reduction of the trapped magnetic flux density became about 2 ppm or about the same result as the case of an NbTi alloy. Further, when the normal conductive material was changed to copper, copper alloy, aluminum, or aluminum alloy to conduct the same magnetization experiment, similar values were obtained.

In the case of a copper alloy or aluminum alloy, compared with copper or aluminum, the rate of magnetization and demagnetization causing a magnetization jump becomes small, but instead the AC-loss in the AC magnetic field can be reduced.

### Example 10

A bulk material of a Y—Ba₂—Ca₃—Ca₃—Cuₓ-based high temperature superconductive oxide of an outside diameter of 43 mm and a thickness of 20 mm was prepared by the melting and rapid cooling method and the same procedure was followed as in Example 1 in liquid nitrogen (temperature 77 K) to conduct measure the change along with time of the temperature and the trapped magnetic flux density. While doing this, a magnetization experiment was conducted.

For the magnetization, as explained below, just the values of Hex1 and Hex2 were changed. The process of magnetization and demagnetization and the process of cooling were performed by the same procedure as in Example 1. The change along with time of the trapped magnetic flux density was measured.

When making μoHex1 3 T and making −μoHex2 −0.5 T, Binmax became 1.5 T.

Regarding the rate of reduction of the drop in the magnetic flux density due to magnetic flux creep from right after the end of the demagnetization, the rate of reduction of the trapped magnetic flux density after 2100 seconds when designating the trapped magnetic flux density at the time of start of measurement as 100% was about 13% in the conventional method, while it could be suppressed to about 5 ppm by the magnetization method of the present invention.

### INDUSTRIAL APPLICABILITY

According to the present invention, it is possible to provide a magnetization method for a superconductive magnet utilizing the magnetic flux trapping characteristics of a type II superconductive material comprising greatly suppressing the sudden drop in the trapped magnetic flux density along with the elapse of time due to the magnetic flux creep and forming a constant magnetic flux density distribution over time and a superconductive magnet having a constant magnetic flux density distribution along with the elapse of time.

Therefore, the above magnetization method and superconductive magnet obtained by the magnetization method have large possibilities of utilization and contribute greatly to the development of industrial technology utilizing superconductivity.

1. A superconductive magnet comprised of a bulk member or sheet member of a type II superconductive material,
said superconductive magnet characterized in that a distribution of the magnetic flux density component vertical to the surface directly above the surface of the bulk member or sheet member
(a) has a maximum value at a center of said bulk member or sheet member and is about zero at its side edge, and
(b) has at least one minimal value point between said center and side edge.

2. A superconductive magnet as set forth in claim 1, characterized in that the distribution of said magnetic flux density component has one maximal value point between the minimal value point closest to said side edge and said side edge.

3. A superconductive magnet as set forth in claim 1 or 2, characterized in that the distribution of said magnetic flux density component has (N−1) number of maximal value points and has N number of minimal value points between said center and side edge and said side edge.

4. A superconductive magnet as set forth in claim 1 or 2, characterized in that the distribution of said magnetic flux density component has N number of maximal value points and N number of minimal value points between said center and side edge.

5. A superconductive magnet as set forth in claim 1 or 2, characterized in that said bulk member or sheet member is comprised of at least N number (where N=2) of bulk members or sheet members of a type II superconductive material stacked in the thickness direction.

6. A superconductive magnet as set forth in claim 1 or 2, characterized in that said bulk member or sheet member is comprised of a type II superconductive material layer and normal conductive material layer stacked alternately and bonded metallically at the stacked boundaries.

7. A superconductive magnet as set forth in claim 6, characterized in that said stacked boundaries have diffusion barrier layers.

8. A superconductive magnet comprised of a seamless cylindrical member of a type II superconductive material,
said superconductive magnet characterized in that a distribution of the magnetic flux density component parallel to the center axis of said cylindrical member in a plane vertical to the center axis
(a) has a maximum value at the inside surface of said cylindrical member and is substantially zero at the outside surface, and further,
(b) has at least one minimal value point between said inside surface and outside surface.

9. A superconductive magnet as set forth in claim 8, characterized in that the distribution of said magnetic flux density component has one maximal value point between the minimal value point closest to said outside surface and said outside surface.

10. A superconductive magnet as set forth in claim 8 or 9, characterized in that the distribution of said magnetic flux density component has (N−1) number of maximal value points and has N number of minimal value points between said inside surface and outside surface.

11. A superconductive magnet as set forth in claim 8 or 9, characterized in that the distribution of said magnetic flux density component has N number of maximal value points and N number of minimal value points between said inside surface and outside surface.

12. A superconductive magnet as set forth in claim 8 or 9, characterized in that said seamless cylindrical member is comprised of at least N number (where N=2) of seamless cylindrical members of a type II superconductive material stacked in the thickness direction.

13. A superconductive magnet as set forth in claim 8 or 9, characterized in that said seamless cylindrical member is comprised of a type II superconductive material layer and normal conductive material layer stacked alternately and bonded metallically at the stacked boundaries.

14. A superconductive magnet as set forth in claim 13, characterized in that said stacked boundaries have diffusion barrier layers.

15. A superconductive magnet as set forth in any one of claims 6, 7, 13, and 14, characterized in that said type II superconductive material is any one of an NbTi-based alloy, Nb₃Sn, and V₃Ga and said normal conductive material is at least one type of material among copper, a copper alloy, aluminum, or an aluminum alloy.

16. A superconductive magnet as set forth in claim 1 or 8, characterized in that said type II superconductive material is an oxide-based superconductive material.

17. A method of production of a superconductive magnet as set forth in claim 5 or 12, characterized in that said N number or more type II superconductive materials are stacked in the thickness direction shifted by angles of (180/N)° each.

18. A magnetization method of a superconductive magnet characterized by:
cooling a superconductor comprised of a bulk member, sheet member, or cylindrical member of a type II superconductive material to not more than a critical temperature while applying a magnetic field Hex1 [A/m] near the magnetic field generation system in the normal conductive state,
reducing the applied magnetic field to zero,
applying a magnetic field until the applied magnetic field becomes −Hex2 [A/m] in the opposite direction to the trapped magnetic flux to make the trapped magnetic flux density Bin0[T], then
again returning the applied magnetic field to zero, where
Hex1>0, Hex2>0.

19. A magnetization method of a superconductive magnet as set forth in claim 18, characterized by: further,
reversing the direction of the applied magnetic field to a direction the same as the trapped magnetic field and applying a magnetic field until Hex3 [A/m], then
returning the applied magnetic field to zero, where
Hex1>0, Hex2>0, Hex3>0.

20. A magnetization method of a superconductive magnet as set forth in claim 19, characterized by: further,
reversing the direction of the applied magnetic field and repeatedly applying the magnetic field until Hex(2N−1) or Hex(2N), and
finally returning the applied magnetic field to zero, where
Hex(2N−1)>0, Hex(2N)>0, N=1, 2, . . . , n (n is a natural number).
